(19) United States
(12) Patent Application Publication
(10) Pub. No.: US 2026/0166863 A1
(43) Pub. Date: Jun. 18, 2026

(54) FLEXIBLE PACKAGING WITH SMART LABEL

(71) Applicant: BROOK & WHITTLE LIMITED, Amherst, NY (US)

(72) Inventor: Sean Patrick Gallagher, Cleves, OH (US)

(21) Appl. No.: 19/330,513

(22) Filed: Sep. 16, 2025

Related U.S. Application Data
(60) Provisional application No. 63/695,663, filed on Sep. 17, 2024.

(51) Int. Cl. B32B 27/08; B32B 7/12; B32B 27/32

(52) U.S. Cl. CPC B32B 27/08; B32B 7/12; B32B 27/32; B32B 2255/10; B32B 2307/75

(57) ABSTRACT

A packing material and a method of making are provided. The packing material has a layered film and a smart label inlay. The layered film includes a metallic layer having a disruption therethrough and a non-metallic layer. The smart label inlay is disposed on the layered film and registered with the disruption in the metallic layer. The disruption enables transmission of the smart label antenna. A flexible packaging is formed of the packing material.

### CROSS REFERENCE TO RELATED APPLICATIONS

This application claims the benefit of U.S. Provisional Patent Application 63/695,663, filed Sep. 17, 2024, the disclosure of which is incorporated by reference herein in its entirety.

### SUMMARY

Some embodiments of the technology disclosed herein relate to a packing material. The packing material has a layered film and a smart label inlay. The layered film includes a metallic layer having a disruption therethrough and a non-metallic layer. The smart label inlay is disposed on the layered film and registered with the disruption in the metallic layer.

In some such embodiments, the metallic layer includes a metal foil or a metalized layer. The non-metallic layer may include a polymer, paper, or both. The non-metallic layer may include one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof. The non-metallic layer may include a first polymeric layer and a second polymeric layer, and the metallic layer may be disposed between the first and second polymeric layers.

Some embodiments of the technology disclosed herein relate to a flexible packaging. The flexible packaging may be constructed of a layered film and a smart label inlay disposed on the layered film. The layered film includes a metallic layer having a disruption therethrough and a non-metallic layer. The smart label is registered with the disruption in the metallic layer.

In some embodiments, the flexible packaging may include a pouch constructed of the packing material. In some such embodiments, the pouch includes a seal defining a closed end and a removable portion configured to remove the seal. The disruption may be disposed in the removable portion.

Some embodiments of the technology disclosed herein relate to a method of making a packing material. The packing material has a layered film. The layered film includes a metallic layer and a non-metallic layer. The method includes creating a disruption in the metallic layer and adhering a smart label inlay to the layered film overlaying the disruption.

### BRIEF DESCRIPTION OF DRAWINGS

FIG. 1A is a schematic perspective view of a flexible packaging with a smart label according to an embodiment.

FIG. 1B is a front view of the flexible packaging of FIG. 1A that has been sealed.

FIG. 2A is a schematic cross sectional view of a metalized flexible material for use in flexible packaging according to an embodiment.

FIG. 2B is a schematic cross sectional view of the metalized flexible material of FIG. 2A including a disruption in the metallic layer.

FIG. 2C is a schematic cross sectional view of the metalized flexible material of FIG. 2B including a smart label registered with the disruption according to an embodiment.

### DETAILED DESCRIPTION

The present disclosure relates to flexible packaging that includes a smart label. In particular, the present disclosure relates to flexible packaging that includes a metallic layer (e.g., metalization or a metal foil) and a smart label.

Certain types of flexible packaging include a metallic layer to provide a barrier layer, opacity, and/or other beneficial properties. The metallic layer may be provided, for example, as a metalization of another layer (e.g., a polymer layer or a paper-based layer), or as a metal film. The metallic layer may be laminated with other layers, such as one or more polymeric layers and/or one or more paper-based layers. The term “metalized flexible packaging” is used here broadly to refer to flexible packaging that includes a metallic layer prepared by any method, including metalization or including a metal foil. The metalized flexible packaging of the present disclosure includes one or more other layer in addition to the metallic layer. The term “flexible packaging” is used in the industry to differentiate from rigid packaging, such as bottles, boxes, and the like. Flexible packaging typically includes bags, pouches, films, and the like.

The term packaging is used here broadly and is not particularly limited. Metalized flexible packaging generally can be used to form various bags, pouches, and wraps. In some embodiments, the metalized flexible packaging of the present disclosure includes or is a bag or a pouch. Such bags or pouches may include stand-up pouches and pillow pouches. In some embodiments, the metalized flexible packaging of the present disclosure includes or is a roll-stock material (not formed into a bag or pouch). The metalized flexible packaging may serve to block light from reaching a product inside the package. The metalized flexible packaging may serve to obscure the contents of the packaging. The metalized flexible packaging may be used to provide graphic elements and information about the product, such as product information required by law, if applicable (e.g., ingredient list, drug content, and/or nutritional facts). The metalized flexible packaging may provide various barrier properties, such as an oxygen barrier, a moisture barrier, a UV barrier, and the like.

In industrial and commercial settings, such as manufacturing, product transport, wholesale, and retail, it may be desirable to include a smart label on individual product packaging. Smart labels include a microchip that can be loaded with information about the product, its identity, manufacturing, and use, etc. Smart labels can allow producers, transporters, retailers, and consumers to easily access information about the product. The information on a smart label can also be read by an automated system. Examples of smart labels include radio-frequency identification (RFID) tags, near field communication (NFC) tags, ultra high frequency (UHF) tags, and the like. A smart label typically includes an inlay with an antenna and a microchip on a substrate, and a sticker or label with an adhesive that allows the smart label to be adhered to a product or its packaging.

However, the presence of a metallic layer on a metalized flexible packaging can cause electromagnetic interference with the smart label. The metallic layer may cause one or both of reflection and absorption of signals such as radio frequency waves. This may cause one or both of dispersion and attenuation of the signals, making it difficult to read the smart label. Thus, improvements to metalized flexible packaging are desired. In particular, it is desired to provide a metalized flexible packaging that is compatible with the use of a smart label. It is desirable to provide a metalized flexible packaging that includes a smart label disposed on the metalized flexible material forming the packaging.

According to embodiments of the present disclosure, a metalized flexible packaging is provided that is compatible with the use of smart labels. The metalized flexible packaging of the present disclosure includes a smart label disposed on the metalized flexible material forming the packaging.

The metalized flexible packaging is made of metalized flexible material. The metalized flexible material includes at least a metallic layer and one or more additional layers. The smart label is applied to the metalized flexible material. According to an embodiment, the smart label is applied onto an area of the metalized flexible material where the metallic layer has been disrupted. The disruption in the metallic layer may reduce the electromagnetic interference, making it easier to read the smart label. For example, a distance range between the smart label and a reader to accurately read the smart label may be increased for a packing material that includes the disruption when compared to a packing material that does not include the disruption.

The disruption in the metallic layer may be achieved by any suitable means, such as by applying one or more perforations, punctures, cut-outs, or a combination of two or more thereof. In some embodiments, the disruption includes laser perforations or cut-outs.

The materials and dimensions of the metalized flexible material and the metalized flexible packaging are not particularly limited. In some embodiments, the metalized flexible material includes a polymer layer or a paper layer or both. In some embodiments, the metalized flexible material includes two or more polymer layers. Any suitable polymers may be used.

Examples of suitable polymers include polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), and copolymers, and blends thereof.

In some embodiments, the metalized flexible material includes a first polymeric layer and a second polymeric layer. The first polymeric layer may include a different type of polymer than the second polymeric layer. Alternatively, the first and second polymeric layers may include the same type of polymer. In some embodiments, the metallic layer is disposed between the first and second polymeric layers. In some embodiments, the metalized flexible material includes more than two polymer layers. In some embodiments, the first polymeric layer includes a polyolefin, such as polyethylene, polypropylene, or a copolymer or blend thereof. In some embodiments, the first polymeric layer includes a polyester, such as polyethylene terephthalate (PET), polylactic acid (PLA), or the like.

The thicknesses of the layers are not particularly limited. In some representative examples, the first polymeric layer may have a thickness of 10 μm or greater, 25 μm or greater, or 50 μm or greater. The first polymeric layer may have a thickness of 500 μm or less, 250 μm or less, 125 μm or less, or 115 μm or less. The second polymeric layer may have a thickness of 5 μm or greater, 10 μm or greater, 15 μm or greater, or 20 μm or greater. The second polymeric layer may have a thickness of 100 μm or less, 50 μm or less, or 25 μm or less. In some specific examples, a certain minimum thickness of the material is desired or even required by law. For example, to provide a child proof packaging, the material may have a minimum total thickness of 100 μm (4 mil).

The metallic layer may have a thickness of 4 μm or greater, 5 μm or greater, 6 μm or greater, 8 μm or greater, 10 μm or greater, or 12 μm or greater. The metallic layer may have a thickness of 50 μm or less, 40 μm or less, 30 μm or less, 25 μm or less, 20 μm or less, or 15 μm or less. The metallic layer may be a metal foil or a non-metal (e.g., polymer) film with metalization.

One or more of the layers may be used to provide a printing web for the packaging. For example, the outer-most polymeric layer may be a printing web and may include indicia.

According to an embodiment, the metallic layer is disrupted (e.g., includes a disruption). The disruption may be in the form of one or more perforations, punctures, cut-outs, or a combination of two or more thereof. The one or more perforations, punctures, and/or cut-outs collectively form and define the disruption. The one or more perforations, punctures, and/or cut-outs collectively define the size of the disruption. The one or more perforations, punctures, and/or cut-outs collectively the shape of the disruption. The size and shape of the disruption is not particularly limited, as long as the disruption allows for the smart label to function as intended, and does not prevent the use of the packaging for its intended purpose. In some embodiments, disruption is sized and shaped such that it enables transmission to and from the smart label. In some embodiments, disruption has a size and shape that are coextensive or substantially coextensive with the smart label inlay. In some embodiments, disruption is sized and shaped such that it increases the readable range of the smart label on the packaging. In some preferred embodiments, the placement, size, and/or shape of the disruption does not compromise the integrity of the packaging.

The disruption may be achieved by any suitable means. In some embodiments, the disruption is applied to the metallic layer by perforating, puncturing, or cutting the metallic layer. In some embodiments, the disruption is applied using a laser. In some embodiments, the disruption is applied by cutting the metallic layer. In some embodiments, the disruption is applied by perforating, puncturing, or cutting the metallic layer and another layer. For example, if the metallic layer is a metalized film disposed on a polymeric film, the disruption may be applied by perforating, puncturing, or cutting both the metallic layer and the polymeric film. The disrupted metallic film may be laminated with additional layers if desired. In some embodiments, metalized flexible material includes a first polymeric layer and a second polymeric layer, and a metallic layer is disposed between the first and second polymeric layers, and the disruption extends through the first polymeric layer or the second polymeric layer but not both.

In some embodiments, the size and shape of the disruption is matched to the size and shape of the smart label inlay. In such embodiments, the disruption may be coextensive with the smart label inlay.

The size of the disruption may be expressed as a percentage of the metallic or metalized layer that is removed by perforating, puncturing, or cutting the metallic or metalized layer. The percentage may be calculated as the area of the holes relative to the area of the disruption as a whole. For example, a plurality of perforations may be made in an area of 2 cm² of the film (the area of the disruption), where the perforations have a total area of 0.5 cm². The area of the perforations is 25% of the area of the disruption. The area of the disruption is arranged to overlay the smart label inlay. The area of the disruption may be arranged to be coextensive the smart label inlay. For the purpose of calculating the percentage of the metal removed in the area of the disruption, the area of the disruption may be defined as including only the area that overlays the smart label inlay. In some embodiments, 20% or more, 25% or more, 30% or more, 40% or more, or 50% or more of the metallic layer is removed in the area of the disruption. Up to 100%, or 99% less, 98% less, 95% less, 90% less, 85% less, 80% less, 75% less, 70% less, 60% less, or 50% less of the metallic layer may be removed in the area of the disruption. In some embodiments, from 20% to 100%, from 20% to 90%, from 20% to 80%, from 20% to 75%, or from 25% to 70% of the metallic layer may be removed in the area of the disruption. In preferred embodiments, removal of the metallic layer means removal of the entire thickness of the metallic layer. That is, removal forms through holes in the metal rather than a mere thinning of the metallic layer.

The terms “smart label” and “smart label inlay” are used here to refer to various types of labels that include an antenna and a readable chip. In some embodiments, the smart label may include a microchip that stores data. In some embodiments, the smart label does not contain a microchip but instead relies on magnetic materials or transistorless thin film circuits to store data. While the latter is sometimes referred to as a “chipless tag” in the art, the term smart label is used here to refer to both embodiments, and reference to a “chip” is understood to include the magnetic material or transistorless thin film circuits capable of storing data. The chip may be configured to store and/or process information. When interrogated by a reading device (also called an interrogator), RFID inlays reflect or retransmit a radio frequency signal to return an encoded identification (ID) to the interrogator. The microchip may also be configured to modulate and demodulate signals. For example, a radio frequency identification (RFID) inlay may include a microchip that reflects or retransmits radio frequency signals to return an encoded identification (ID) to an interrogator or reading device. According to various examples, the radio frequency signals are ultra-high frequency (UHF) radio frequency signals. The smart label may include other types of technology such as low energy wireless, Bluetooth, near field communication (NFC), long-term evolution (LTE), ZigBee, and other wireless protocols, for example.

In some embodiments, the smart label comprises an RFID inlay. In some embodiments, the RFID inlay utilizes a wireless protocol selected from radio frequency, ultra-high frequency (UHF), low energy wireless, Bluetooth, near field communication (NFC), long-term evolution (LTE), and ZigBee.

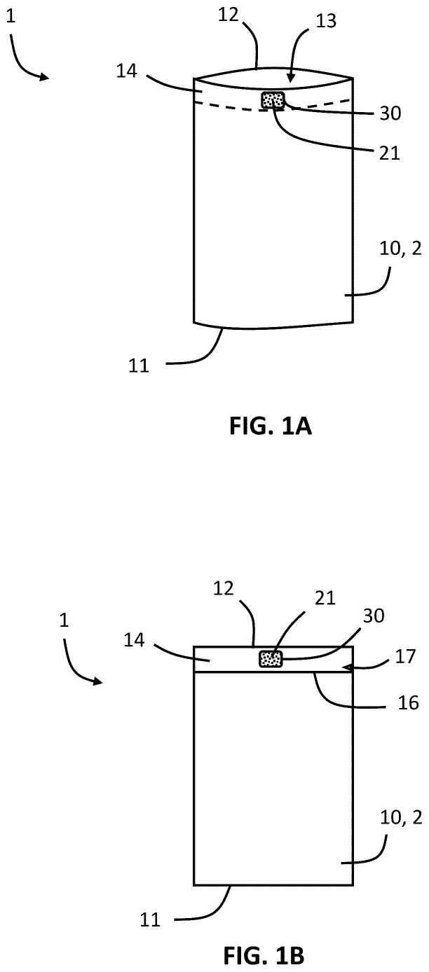

Referring now to FIGS. 1A and 1B, an exemplary embodiment of a flexible packaging 1 with a smart label 30 is shown. In the exemplary embodiment, the flexible packaging 1 is a pouch having a body 10 formed of metalized flexible material. The flexible packaging 1 has a closed bottom 11, a top 12, and an interior 13. In FIG. 1A, the flexible packaging 1 is open. The flexible packaging 1 includes a removable portion 14, defined by the dotted line in FIG. 1A. According to an embodiment, the disruption 21 and the smart label inlay 30 are positioned in the removable portion 14. Although the disruption 21 and the smart label inlay 30 are shown in the figures, they may be placed on an inside layer or in a middle (e.g., intermediate) layer, invisible to a user. After the flexible packaging 1 has been filled with product, the flexible packaging 1 may be closed or sealed along sealing line 16. The sealing line 16 may include a melt seal or a zipper closure or both. The flexible packaging 1 may optionally include a notch 17 or perforations to enable a user to easily remove the removable portion 14. The removable portion 14 may be the portion approximately between the sealing line 16 and the top 12 of the pouch.

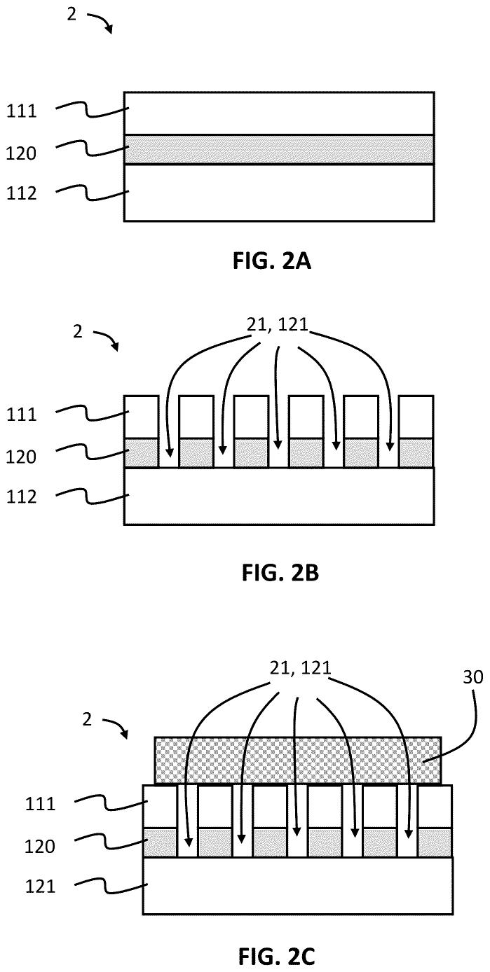

FIG. 2A is an exemplary embodiment of a metalized flexible material 2 for use in flexible packaging according to an embodiment. The metalized flexible material 2 is a layered material, including a metallic layer 120 and at least one other layer. In the embodiment shown, the metalized flexible material 2 includes a metallic layer 120 between a first non-metallic layer 111 (e.g., a first polymeric layer) and a second non-metallic layer 112 (e.g., a second polymeric layer).

According to an embodiment, the metallic layer 120 includes a disruption 21, as shown in FIG. 2B. The disruption 21 may be formed by a plurality of perforations 121. The perforations 121 extend through the metallic layer 120. The perforations 121 may also extend through one of the non-metallic layers, for example the first non-metallic layer 111, as shown.

According to an embodiment, the metalized flexible material 2 includes a smart label inlay 30 that is adhered to a surface of the film in the area of the disruption 21. In the embodiment shown, the smart label inlay 30 is adhered to the first non-metallic layer 111, on the side of the perforations 121. In some other embodiments, the smart label inlay 30 may be adhered opposite of the side of the perforations 121. In further other embodiments, the smart label inlay 30 may be disposed between layers of the metalized flexible material 2. The metalized flexible material 2 may include additional layers in addition to those shown.

Methods of making metalized flexible materials and metalized flexible packaging may include various steps, such as preparing layered films, vacuum depositing, extruding, metalizing, laminating, printing, cutting, seaming, etc. According to an embodiment, the method includes disrupting the metallic layer of a layered film. This can be either a metalized film (e.g., a metalized polymeric film) or a metal foil. The disrupting of the metallic layer can be performed on the metallic layer alone, or on the metallic film and at least one other layer, such as a polymeric layer adjacent to the metallic layer.

According to an embodiment, the metallic layer is disrupted using perforation, puncturing, cutting, or the like. In some embodiments, the metallic layer is disrupted using laser perforation, laser cutting, mechanical tool cutting, or the like. In some embodiments, the disruption is formed by laser scoring through a composite of a metallic layer and at least one polymeric layer. The depth of the laser scoring may be controlled so that the perforations extend only through the metallic layer and one polymeric layer. One or more polymeric layers may remain intact. The perforated material may be further laminated with other layers.

According to an embodiment, the method includes adhering a smart label inlay onto the metalized flexible material in the area of the disruption. The smart label inlay may be adhered onto the disruption or onto an opposite side of the metalized flexible material. In some embodiments, the disruption and the smart label inlay are applied in a continuous process. The smart label inlay may be registered with the disruption. The smart label inlay may be registered with the disruption using marking on a continuous metalized flexible material.

The metalized flexible material may be used to form metalized flexible packaging. The packaging may be formed such that the disruption and the smart label inlay remain in a removable portion of the packaging, as shown in FIGS. 1A and 1B. Alternatively, the disruption and the smart label inlay are in another area of the packaging (e.g., in an area that remains intact or is not removable). In some embodiments, the disruption is applied during or in conjunction with another method step in the process of making metalized flexible packaging. For example, the disruption may be applied during or in conjunction with a slitting process or pouch converting process and may be registered within the area of material used to prepare a packaging. The slitting process is a process where the film is taken from its wide width in a laminator, to a narrower width, prior to a converting process, where the narrower film is converted to its final form, e.g., a bag or a pouch.

In some embodiments, the disruption in the metallic layer is a continuous line of perforations, punctures, or cut-outs. Such a continuous line may be placed at a removable portion of the packaging.

In some embodiments, disruptions and smart label inlays placed on the disruptions are applied onto so called roll-stock film of metalized flexible material. Such roll-stock film may be used later to form packaging or other items that include metalized film and smart label inlays.

### EXAMPLES

The ability to read an RFID tag through metalized PET film with and without disruption of the metalized layer was tested.

Samples were prepared from metalized PET by applying various perforations using a laser cutter. The perforations extended through the metalized layer but not through the printing layer. The perforations ranged from pin holes to rectangular cuts. The perforations were arranged in a shape and size of the RFID tag inlay. The RFID inlay was adhered to the film with an adhesive, registering the RFID tag with the perforations. A control sample included an RFID adhered to non-perforated film. The ability to read the RFID tag was tested using a handheld reader from the side opposite of the RFID tag.

It was observed that the RFID tag could be read through each of the disrupted (perforated) films but could not be read through the non-perforated film of the control. It was concluded that disrupting the metalized layer does allow for a reader to read a smart label through the packaging film.

As long as the perforations provide sufficient disruption of the metalized layer, smaller perforations are preferred to avoid compromising the sealant layer. It was concluded that the small pinholes provide sufficient disruption of the metalized layer and also minimize disruption of the sealant layer.

### EMBODIMENTS

Embodiment 1 is a packing material comprising:
a layered film comprising:
a metallic layer having a disruption therethrough; and
a non-metallic layer; and
a smart label inlay disposed on the layered film and registered with the disruption in the metallic layer.

Embodiment 2 is the packing material of embodiment 1, wherein the metallic layer comprises a metal foil or a metalized layer.

Embodiment 3 is the packing material of embodiments 1 or 2, wherein the non-metallic layer comprises a polymer or paper.

Embodiment 4 is the packing material of any one of embodiments 1 to 3, wherein the non-metallic layer comprises one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof.

Embodiment 5 is the packing material of any one of embodiments 1 to 4, wherein the non-metallic layer comprises a first polymeric layer and wherein the layered film further comprises a second polymeric layer, and wherein the metallic layer is disposed between the first and second polymeric layers.

Embodiment 6 is the packing material of embodiment 5, wherein the first polymeric layer has a thickness in a range of 10 μm to 500 μm, 10 μm to 250 μm, or 25 μm to 125 μm.

Embodiment 7 is the packing material of embodiment 5 or 6, wherein the second polymeric layer has a thickness in a range of 5 μm to 100 μm, 10 μm to 50 μm, or 15 μm to 25 μm.

Embodiment 8 is the packing material of any one of embodiments 5 to 7, wherein the first polymeric layer comprises indicia.

Embodiment 9 is the packing material of any one of embodiments 5 to 8, wherein the first polymeric layer comprises a polyolefin, optionally wherein the first polymeric layer comprises polyethylene, polypropylene, or a copolymer or blend thereof.

Embodiment 10 is the packing material of any one of embodiments 1 to 9, wherein the metallic layer has a thickness in a range of 4 μm to 50 μm, 5 μm to 25 μm, or 6 μm to 20 μm.

Embodiment 11 is the packing material of any one of embodiments 1 to 10, wherein the disruption comprises one or more perforations, punctures, cut-outs, or a combination of two or more thereof.

Embodiment 12 is the packing material of any one of embodiments 1 to 11, wherein the disruption comprises laser perforations or mechanical perforations.

Embodiment 13 is the packing material of any one of embodiments 1 to 12, wherein the non-metallic layer comprises a first polymeric layer and wherein the layered film further comprises a second polymeric layer, and wherein the metallic layer is disposed between the first and second polymeric layers, and wherein the disruption extends through the first polymeric layer or the second polymeric layer but not both.

Embodiment 14 is the packing material of any one of embodiments 1 to 13, wherein the disruption is coextensive with the smart label inlay.

Embodiment 15 is a flexible packaging comprising:
a pouch constructed of a layered film comprising:
a metallic layer having a disruption therethrough; and
a non-metallic layer; and
a smart label inlay disposed on the layered film and registered with the disruption in the metallic layer.

Embodiment 16 is the flexible packaging of embodiment 15, wherein the pouch comprises a seal defining a closed end and a removable portion configured to remove the seal, and wherein the disruption is disposed in the removable portion.

Embodiment 17 is the flexible packaging of embodiments 15 or 16, wherein the metallic layer comprises a metal foil or a metalized layer.

Embodiment 18 is the flexible packaging of any one of embodiments 15 to 17, wherein the non-metallic layer comprises a polymer or paper.

Embodiment 19 is the flexible packaging of any one of embodiments 15 to 18, wherein the non-metallic layer comprises one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof.

Embodiment 20 is the flexible packaging of any one of embodiments 15 to 19, wherein the non-metallic layer comprises a first polymeric layer and wherein the layered film further comprises a second polymeric layer, and wherein the metallic layer is disposed between the first and second polymeric layers.

Embodiment 21 is the flexible packaging of embodiment 20, wherein the first polymeric layer has a thickness in a range of 10 μm to 500 μm, 10 μm to 250 μm, or 25 μm to 125μm.

Embodiment 22 is the flexible packaging of embodiment 20 or 21, wherein the second polymeric layer has a thickness in a range of 5 μm to 100 μm, 10 μm to 50 μm, or 15 μm to 25 μm.

Embodiment 23 is the flexible packaging of any one of embodiments 20 to 22, wherein the first polymeric layer comprises indicia.

Embodiment 24 is the flexible packaging of any one of embodiments 20 to 23, wherein the first polymeric layer comprises a polyolefin, optionally wherein the first polymeric layer comprises polyethylene, polypropylene, or a copolymer or blend thereof.

Embodiment 25 is the flexible packaging of any one of embodiments 15 to 24, wherein the metallic layer has a thickness in a range of 4 μm to 50 μm, 5 μm to 25 μm, or 6 μm to 20 μm.

Embodiment 26 is the flexible packaging of any one of embodiments 15 to 25, wherein the disruption comprises one or more perforations, punctures, cut-outs, or a combination of two or more thereof.

Embodiment 27 is the flexible packaging of any one of embodiments 15 to 26, wherein the disruption comprises laser perforations or mechanical perforations.

Embodiment 28 is the flexible packaging of any one of embodiments 15 to 27, wherein the non-metallic layer comprises a first polymeric layer and wherein the layered film further comprises a second polymeric layer, and wherein the metallic layer is disposed between the first and second polymeric layers, and wherein the disruption extends through the first polymeric layer or the second polymeric layer but not both.

Embodiment 29 is the flexible packaging of any one of embodiments 15 to 28, wherein the disruption is coextensive with the smart label inlay.

Embodiment 30 is a method of making a packing material, the packing material comprising:
a layered film comprising:
a metallic layer; and
a non-metallic layer; and
the method comprising:
creating a disruption in the metallic layer; and
adhering a smart label inlay to the layered film, overlaying the disruption.

Embodiment 31 is the method of embodiment 30, wherein the metallic layer comprises a metal foil or a metalized layer.

Embodiment 32 is the method of embodiments 30 or 31, wherein the non-metallic layer comprises a polymer or paper.

Embodiment 33 is the method of embodiments 30 to 32, wherein the non-metallic layer comprises one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof.

Embodiment 34 is the method of any one of embodiments 30 to 33, wherein the non-metallic layer comprises a first polymeric layer and wherein the layered film further comprises a second polymeric layer, and wherein the metallic layer is disposed between the first and second polymeric layers.

Embodiment 35 is the method of embodiment 34, wherein the first polymeric layer has a thickness in a range of 10 μm to 500 μm, 10 μm to 250 μm, or 25 μm to 125 μm.

Embodiment 36 is the method of embodiment 34 or 35, wherein the second polymeric layer has a thickness in a range of 5 μm to 100 μm, 10 μm to 50 μm, or 15 μm to 25 μm.

Embodiment 37 is the method of any one of embodiments 34 to 36, wherein the first polymeric layer comprises indicia.

Embodiment 38 is the method of any one of embodiments 34 to 37, wherein the first polymeric layer comprises a polyolefin, optionally wherein the first polymeric layer comprises polyethylene, polypropylene, or a copolymer or blend thereof.

Embodiment 39 is the method of any one of embodiments 30 to 38, wherein the metallic layer has a thickness in a range of 4 μm to 50 μm, 5 μm to 25 μm, or 6 μm to 20 μm.

Embodiment 40 is the method of any one of embodiments 30 to 39, wherein the disruption comprises one or more perforations, punctures, cut-outs, or a combination of two or more thereof.

Embodiment 41 is the method of any one of embodiments 30 to 40, wherein the disruption comprises laser perforations or mechanical perforations.

Embodiment 42 is the method of any one of embodiments 30 to 41, wherein the non-metallic layer comprises a first polymeric layer and wherein the layered film further comprises a second polymeric layer, and wherein the metallic layer is disposed between the first and second polymeric layers, and wherein the disruption extends through the first polymeric layer or the second polymeric layer but not both.

Embodiment 43 is the method of any one of embodiments 30 to 42, wherein the disruption is coextensive with the smart label inlay.

Embodiment 44 is the packing material, flexible packaging, or method of any one of embodiments 1 to 43, wherein the disruption comprises one or more perforations, punctures, cut-outs, or a combination thereof, and wherein the one or more perforations, punctures, and/or cut-outs collectively define the size of the disruption.

Embodiment 45 is the packing material, flexible packaging, or method of embodiment 44, wherein the size of the disruption is coextensive or substantially coextensive with the smart label inlay, and/or wherein the shape of the disruption is coextensive or substantially coextensive with the smart label inlay.

Embodiment 46 is the packing material, flexible packaging, or method of any one of embodiments 1 to 45, wherein the disruption has an area and comprises one or more perforations, punctures, cut-outs, or a combination thereof, wherein the one or more perforations, punctures, and/or cut-outs define a total area of removed metallic layer, and wherein the total area of removed metallic layer is 20% or more, 25% or more, 30% or more, 40% or more, or 50% or more of the area of the disruption.

Embodiment 47 is the packing material, flexible packaging, or method of embodiment 46, wherein the total area of removed metallic layer is up to 100%, or 99% less, 98% less, 95% less, 90% less, 85% less, 80% less, 75% less, 70% less, 60% less, or 50% less of the area of the disruption.

Embodiment 48 is the packing material, flexible packaging, or method of embodiment 46, wherein the total area of removed metallic layer is from 20% to 100%, from 20% to 90%, from 20% to 80%, from 20% to 75%, or from 25% to 70% of the area of the disruption.

Embodiment 49 is the packing material, flexible packaging, or method of any one of embodiments 46 to 48, wherein removal of the metallic layer comprises removal of the entire thickness of the metallic layer.

1. A packing material comprising:
a layered film comprising:
a metallic layer having a disruption therethrough; and
a non-metallic layer; and
a smart label inlay disposed on the layered film and registered with the disruption in the metallic layer.

2. (canceled)

3. (canceled)

4. The packing material of claim 1, wherein the non-metallic layer comprises one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof.

5. The packing material of claim 1, wherein the non-metallic layer comprises a first polymeric layer and wherein the layered film further comprises a second polymeric layer, wherein the metallic layer is disposed between the first and second polymeric layers, and wherein the first polymeric layer has a thickness in a range of 10 μm to 500 μm and the second polymeric layer has a thickness in a range of 5 μm to 100 μm.

6-9. (canceled)

10. The packing material of claim 1, wherein the metallic layer has a thickness in a range of 4 μm to 50 μm.

11. The packing material of claim 1, wherein the disruption comprises one or more perforations, punctures, cut-outs, or a combination of two or more thereof.

12. The packing material of claim 11, wherein the disruption comprises laser perforations or mechanical perforations.

13. The packing material of claim 1, wherein the non-metallic layer comprises a first polymeric layer and wherein the layered film further comprises a second polymeric layer, wherein the metallic layer is disposed between the first and second polymeric layers, and wherein the disruption extends through the first polymeric layer or the second polymeric layer but not both.

14. The packing material of claim 1, wherein the disruption is coextensive with the smart label inlay.

15. A flexible packaging comprising:
a pouch constructed of a layered film comprising:
a metallic layer having a disruption therethrough; and
a non-metallic layer; and
a smart label inlay disposed on the layered film and registered with the disruption in the metallic layer.

16. The flexible packaging of claim 15, wherein the pouch comprises a seal defining a closed end and a removable portion configured to remove the seal, and wherein the disruption is disposed in the removable portion.

17. (canceled)

18. (canceled)

19. The flexible packaging of claim 15, wherein the non-metallic layer comprises one or more of polypropylene (PP), polyethylene (PE), polyethylene terephthalate (PET), polyethylene terephthalate glycol-modified (PETG or PET-G), polyvinyl chloride (PVC), polystyrene or oriented polystyrene (OPS), polylactic acid (PLA), copolymers, and blends thereof.

20. The flexible packaging of claim 15, wherein the non-metallic layer comprises a first polymeric layer and wherein the layered film further comprises a second polymeric layer, wherein the metallic layer is disposed between the first and second polymeric layers, and wherein the first polymeric layer has a thickness in a range of 10 μm to 500 μm and the second polymeric layer has a thickness in a range of 5 μm to 100 μm.

21-24. (canceled)

25. The flexible packaging of claim 15, wherein the metallic layer has a thickness in a range of 4 μm to 50 μm.

26. The flexible packaging of claim 15, wherein the disruption comprises one or more perforations, punctures, cut-outs, or a combination of two or more thereof.

27. The flexible packaging of claim 15, wherein the disruption comprises laser perforations or mechanical perforations.

28. The flexible packaging of claim 15, wherein the non-metallic layer comprises a first polymeric layer and wherein the layered film further comprises a second polymeric layer, and wherein the metallic layer is disposed between the first and second polymeric layers, and wherein the disruption extends through the first polymeric layer or the second polymeric layer but not both.

29. The flexible packaging of claim 15, wherein the disruption is coextensive with the smart label inlay.

30. A method of making a packing material, the packing material comprising:
a layered film comprising:
a metallic layer; and
a non-metallic layer; and
the method comprising:
creating a disruption in the metallic layer; and
adhering a smart label inlay to the layered film, overlaying the disruption.

31-39. (canceled)

40. The method of claim 30, wherein the disruption comprises one or more perforations, punctures, cut-outs, or a combination of two or more thereof.

41. (canceled)

42. (canceled)

43. The method of claim 30, wherein the disruption is coextensive with the smart label inlay.
